(19) United States
(12) Patent Application Publication
(10) Pub. No.: US 2017/0149474 A1
(43) Pub. Date: May 25, 2017

(54) ELECTRONIC DEVICE AND ACCESSORY DEVICE OF THE ELECTRONIC DEVICE

(71) Applicant: Samsung Electronics Co., Ltd, Gyeonggi-do (KR)

(72) Inventor: Yong-Youn Kim, Gyeonggi-do (KR)

(21) Appl. No.: 15/356,458

(22) Filed: Nov. 18, 2016

(30) Foreign Application Priority Data
Nov. 19, 2015 (KR) 10-2015-0162639

(51) Int. Cl. H04B 5/00; H04B 1/3888

(52) U.S. Cl. CPC H04B 5/0075; H04B 1/3888; H04B 5/0037; H04M 2250/04

(57) ABSTRACT

An electronic device and an accessory device for use therewith. The accessory device includes a first cover configured to detachably engage with the electronic device and cover at least a part of a second surface of the electronic device. A second member disposed on an inner or outer surface of the first cover includes a material attracted to at least one of a magnetic body or a magnet. Moreover, when seen from above the first cover in a direction perpendicular to the first cover, the second member is substantially at a center of the first cover. The accessory device further includes a second cover rotatably connected to the first cover and configured to open or close the first surface of the electronic device. In some embodiments, the electronic device includes a housing with a conductive pattern provided therein which is configured to wirelessly receive external power using the conductive pattern.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Nov. 19, 2015 and assigned Serial No. 10-2015-0162639, the entire disclosure of which is incorporated herein by reference.

### TECHNICAL FIELD

The present disclosure relates generally to an electronic device and an accessory device of the electronic device; and more particularly, to an electronic device for wirelessly charging a battery, and an accessory device of the electronic device.

### BACKGROUND

In general, an electronic device is a device that executes a specific function according to a loaded program, such as a home appliance, an electronic note, a portable multimedia player (PMP), a mobile communication terminal, a tablet personal computer (PC), a video/audio device, a desktop/laptop computer, an in-vehicle navigator, and the like. For example, these electronic devices may output stored information visually or audibly. Along with an increase in the integration level of electronic devices and the increasing popularity of ultra-high-speed, large-capacity wireless communication, various functions have recently been loaded in a single mobile communication terminal.

A battery mounted in an electronic device may be charged wirelessly as well as via a wired connection to an external power source. For wireless charging, a magnetic induction scheme based on electromagnetic induction and a magnetic resonance scheme that generates a resonant frequency are available.

A battery of an electronic device equipped with a magnetic induction-based wireless charging function may be conveniently charged simply by placing the electronic device on an external electronic device (for example, a wireless charger). After sensing arrangement of the electronic device on the external electronic device, the external electronic device may charge the battery of the electronic device through electromagnetic induction.

However, if an accessory device (for example, a protection cover) surrounds the electronic device to protect the electronic device, this accessory device exists between the external electronic device (for example, the wireless charger) and the electronic device. As a result the external electronic device may fail to sense the electronic device, thus not performing wireless charging.

The above information is presented as background information only to assist with an understanding of the present disclosure. No determination has been made, and no assertion is made, as to whether any of the above might be applicable as prior art with regard to the present disclosure.

### SUMMARY

To address the above-discussed deficiencies, it is a primary object to provide an electronic device for enabling an external electronic device to sense the electronic device and wirelessly charge the electronic device, even though an accessory device is engaged with the electronic device, and an accessory device of the electronic device.

Various embodiments of the present disclosure provide an electronic device for enabling smooth wireless charging through alignment between a coil of an external electronic device and a coil of the electronic device, and an accessory device of the electronic device.

In accordance with an embodiment of the present disclosure, there is provided an electronic device. The electronic devices includes a housing having a first surface facing in a first direction, and a second surface facing in a second direction opposite to the first direction, a conductive pattern provided inside the housing, a first member provided between separated portions of the conductive pattern, and containing a material attracted to a magnetic body or a magnet. Additionally, a second member is overlapped at least partially with the first member, when seen from above the housing, apart from the first member in the first or second direction, and containing a material attracted to a magnetic body or a magnet, and a circuit connected electrically to the conductive pattern. The circuit is configured to wirelessly receive external power using the conductive pattern.

In accordance with another embodiment of the present disclosure, there is provided an accessory device detachably engaged with an electronic device having a first surface with a display and a second surface facing in a direction opposite to the first surface. The accessory device includes a first cover for covering at least a part of the second surface of the electronic device, and a second member disposed on an inner or outer surface of the first cover and containing a material attracted to a magnetic body or a magnet. When seen from above the first cover, the second member is disposed substantially at the center of the first cover.

Other aspects, advantages, and salient features of the disclosure will become apparent to those skilled in the art from the following detailed description, which, taken in conjunction with the annexed drawings, discloses exemplary embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a perspective view illustrating an electronic device according to various embodiments of the present disclosure;

FIG. 2 is a view illustrating a network environment including an electronic device according to various embodiments of the present disclosure;

FIG. 3 is a block diagram of an electronic device according to various embodiments of the present disclosure;

FIG. 4 is a sectional view illustrating an electronic device engaged with an accessory according to various embodiments of the present disclosure;

FIG. 5 is a plan view illustrating a conductive pattern and a first member in an electronic device according to various embodiments of the present disclosure;

FIG. 6 is a sectional view illustrating an electronic device engaged with an accessory, which has been placed on a wireless charger according to various embodiments of the present disclosure;

FIG. 7 is a block diagram of a wireless charging system according to various embodiments of the present disclosure;

FIG. 8 is a plan view illustrating a second member partially overlapped with a conductive pattern according to one of various embodiments of the present disclosure; and

FIG. 9 is a plan view illustrating an accessory device according to various embodiments of the present disclosure.

Throughout the drawings, like reference numerals will be understood to refer to like parts, components, and structures.

### DETAILED DESCRIPTION

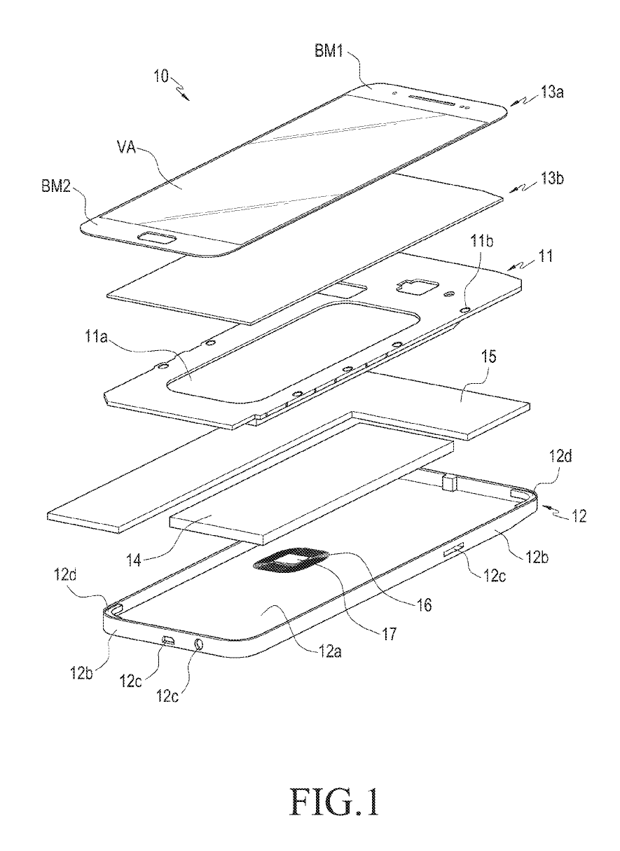

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device.

Various embodiments of the present disclosure are described with reference to the accompanying drawings. However, the scope of the present disclosure is not intended to be limited to the particular embodiments and terms used in the embodiments, and it is to be understood that the present disclosure covers all modifications, equivalents, and/or alternatives falling within the scope and spirit of the present disclosure. In relation to a description of the drawings, like reference numerals denote the same components. It is to be understood that singular forms include plural forms as well, unless the context clearly dictates otherwise.

In various embodiments of the present disclosure, the term ‘A or B’, or ‘at least one of A or/and B’ may cover all possible combinations of enumerated items. The term, ‘first’ or ‘second’ may modify the names of various components irrespective of sequence or importance, not limiting the components. These expressions may be used to distinguish one component from another component, not limiting the components. When it is said that a component (for example, a first component) is ‘(operatively or communicatively) coupled with/to’ or ‘connected to’ another component (for example, a second component), it should be understood that the one component is connected to the other component directly or through any other component (for example, a third component).

In various embodiments of the present disclosure, the term ‘configured to’ as used herein may be interchangeable with, for example, the term ‘suitable for’ ‘having the capacity to’, ‘designed to’, ‘adapted to’, ‘made to’, or ‘capable of’ in hardware or software under circumstances. In some cases, the expression ‘a device configured to’ may mean that a device is ‘capable of’ with another device or part. For example, ‘a processor configured to execute A, B, and C’ may mean a dedicated processor (for example, an embedded processor) for performing the corresponding operations or a generic-purpose processor (for example, a central processing unit (CPU) or an application processor (AP)) for performing the corresponding operations by executing one or more software programs stored in a memory.

An electronic device according to various embodiments of the present disclosure may be at least one of, for example, a smartphone, a tablet personal computer (PC), a mobile phone, a video phone, an e-book reader, a desktop PC, a laptop PC, a netbook computer, a workstation, a server, a personal digital assistant (PDA), a portable multimedia player (PMP), an MP3 player, a mobile medical equipment, a camera, or a wearable device. The wearable device may be at least one of an accessory type (for example, a watch, a ring, a bracelet, an ankle bracelet, a necklace, glasses, contact lenses, or a head-mounted device (HMD)), a fabric or clothes type (for example, electronic clothes), a body-attached type (for example, a skin pad or a tattoo), or an implantable circuit. According to some embodiments, an electronic device may be at least one of, for example, a television (TV), a digital versatile disk (DVD) player, an audio player, a refrigerator, an air conditioner, a vacuum cleaner, an oven, a microwave oven, a washer, an air purifier, a set-top box, a home automation control panel, a security control panel, a media box (for example, Samsung HomeSync™, Apple TV™, Google TV™, or the like), a game console (for example, Xbox™ PlayStation™, or the like), an electronic dictionary, an electronic key, a camcorder, or an electronic picture frame.

According to other embodiments, an electronic device may be at least one of a medical device (for example, a portable medical meter such as a blood glucose meter, a heart rate meter, a blood pressure meter, or a body temperature meter, a magnetic resonance angiography (MRA) device, a magnetic resonance imaging (MM) device, a computed tomography (CT) device, an imaging device, an ultrasonic device, or the like), a navigation device, a global navigation satellite system (GNSS), an event data recorder (EDR), a flight data recorder (FDR), an automotive infotainment device, a naval electronic device (for example, a naval navigation device, a gyrocompass, or the like), an avionic electronic device, a security device, an in-vehicle head unit, an industrial or consumer robot, a drone, an automatic teller machine (ATM) in a financial facility, a point of sales (POS) device in a shop, or an Internet of things (IoT) device (for example, a lighting bulb, various sensors, an electricity or gas meter, a sprinkler, a fire alarm, a thermostat, a street lamp, a toaster, sports goods, a hot water tank, a heater, or a boiler). According to some embodiments, an electronic device may be at least one of furniture, part of a building/structure or a car, an electronic board, an electronic signature receiving device, a projector, or various measuring devices (for example, water, electricity, gas or electro-magnetic wave measuring devices). According to various embodiments, an electronic device may be a flexible electronic device, or may be one or a combination of two or more of the foregoing devices. According to various embodiments of the present disclosure, the term ‘user’ may refer to a person or device (for example, artificial intelligence electronic device) that uses an electronic device.

FIG. 1 is a perspective view illustrating an electronic device according to various embodiments of the present disclosure.

Referring to FIG. 1, an electronic device 10 according to various embodiments of the present disclosure may include a support member 11, a case member 12, a front cover 13a, a battery 14, a circuit board 15, a conductive pattern 16, and a first member 17.

The support member 11 may maintain and complement the strength of the electronic device 10, supporting and fixing the front cover 13a. A display panel 13b may be disposed beneath the front cover 13a, and the support member 11 may support and protect the display panel 13b. For example, various kinds of electronic parts, for example, an integrated circuit (IC) chip such as a processor or a communication module is arranged inside the electronic device 10, and the support member 11 may prevent these electronic parts from interfering with the display panel 13b. According to various embodiments, the support member 11 may also be used as a shield member that prevents electromagnetic interference between various kinds of electronic parts. According to various embodiments of the present disclosure, the support member 11 may include an opening 11a penetrating through front and rear surfaces of the support member 11. The opening 11a is formed in at least a part of an area corresponding to the later-described battery 14, and the battery 14 may be disposed partially in the opening 11a. Clamping bosses 11b may be formed on the support member 11, around the opening 11a or along edges of the support member 11. The clamping bosses 11b may provide a means for engaging and attaching the support member 11 with and to the case member 12.

The case member 12 may form the exterior of the electronic device 10, for example, a rear surface and/or side surfaces of the electronic device 10, and may be disposed to surround at least side surfaces of the support member 11. The case member 12 may include a rear surface portion 12a facing the other surface (for example, rear surface) of the support member 11, and a first sidewall portion 12b extended from the rear surface portion 12a to surround the side surfaces of the support member 11. When the support member 11 is engaged with the case member 12, a space may be formed, surrounded by the support member 11, the rear surface portion 12a, and the first sidewall portion 12b. The afore-mentioned battery 14 or electronic parts may be accommodated in the space. The first sidewall portion 12b may form the whole side surfaces of the electronic device 10, and include a plurality of through holes 12c. The through holes 12c may provide a space in which a power key or a volume key may be arranged, a path connected to an interface connector, a jack connector, or sockets for various storage media (for example, a user identification module card or a memory card).

At least one support piece 12d may be formed at each of both lengthwise ends of the case member 12. In the embodiment, it is assumed that there is a plurality of support pieces 12d, by way of example, for the convenience of description. The support pieces 12d may be extended from end portions of the first sidewall portion 12b toward the inside of the case member 12. The support pieces 12d may be attached to parts (for example, edges of an upper end portion and/or a lower end portion) of the front cover 13a, thereby providing a means for supporting and fixing the front cover 13a.

The front cover 13a may be fixedly attached to one surface (for example, a front surface) of the support member 11, and form the exterior of the electronic device 10, together with the case member 12. When the front cover 13a is fixedly attached to the support member 11, the case member 12 may surround the periphery of the front cover 13a. The parts of the upper end portion and/or lower end portion of the front cover 13a may be fixedly attached to the support pieces 12d. For example, the front cover 13a may be surrounded by the upper end portion of the first sidewall portion 12b, and at least one of both lengthwise ends of the front cover 13a may be fixedly attached to the support pieces 12d.

The front cover 13a and the display panel 13b may collectively form a display device. The front cover 13a may transmit an image or a video generated by the display panel 13b and protect the display panel 13b from an ambient environment. The front cover 13a may include a screen transmission area VA corresponding to the display panel 13b, and a printed area BM1 and/or BM2 defined on one portion and/or the other portion of the screen transmission area VA. An input device such as a touch key, a receiver for voice call, an opening for taking a picture, a proximity/illumination sensor, and so on may be arranged in the printed area BM1 and/or BM2. For example, the printed areas BM1 and BM2 may be provided on both lengthwise ends of the electronic device 10, for example, one on each of the upper and lower end portions of the electronic device 10.

The front cover 13a and the case member 12 may form a housing serving as the exterior of the electronic device. For example, the housing may include the front cover 13a forming a first surface of the housing, facing in a first direction, and the case member 12 forming a second surface of the housing, facing in a second direction opposite to the first direction.

The battery 14 may be mounted in a space formed between the case member 12 and the support member 11, and may be positioned partially in the opening 11a. The battery 14 may be connected electrically to the later-described circuit board 15.

Various kinds of electronic parts, for example, a processor, a memory, a sensor module, an input device, an interface, an audio module, a power management module, and so on may be loaded on or connected to the circuit board 15. With the battery 14 mounted in the space formed between the case member 12 and the support member 11, the circuit board 15 may be disposed in an area around the battery 14. Although the single circuit board 15 may be provided in the electronic device 10, the present disclosure is not limited thereto. For example, a plurality of circuit boards may be arranged in the space between the case member 12 and the support member 11, and electronic parts may be distributed or combined on the plurality of circuit boards according to their functions and relationship.

The conductive pattern 16 may be provided between the battery 14 and the case member 12, and connected electrically to the circuit board 15. The conductive pattern 16 may be configured as a coil and formed of a metallic material. However, the conductive pattern 16 may be formed of various conductive materials, not limited to a metallic material. The conductive pattern 16 may perform a wireless charging function of charging a battery through external electromagnetic induction. The first member 17 may be disposed in a center area of the conductive pattern 16 and formed of a material attracted to a magnetic body or a magnet. The conductive pattern 16 and the first member 17 will be described later in detail with reference to the drawings.

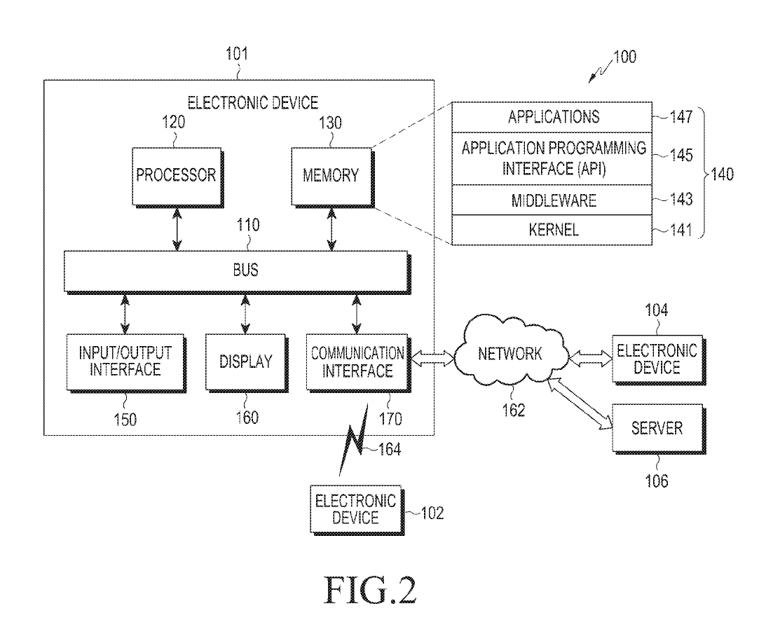

FIG. 2 is a view illustrating a network environment including an electronic device according to various embodiments of the present disclosure.

Referring to FIG. 2, an electronic device 101 in a network environment 100 according to various embodiments is described. The electronic device 101 may include, for example, the whole or part of the electronic device 10 illustrated in FIG. 1. The electronic device 101 may include a bus 110, a processor 120, a memory 130, an input/output (I/O) interface 150, a display 160, and a communication interface 170. In some embodiments, at least one of the components may be omitted in the electronic device 101 or a component may be added to the electronic device 101. The bus 110 may include a circuit that interconnects the foregoing components 120, 130, 150, 160, and 170 and allows communication (for example, control messages and/or data) between the foregoing components. The processor 120 may include one or more of a CPU, an AP, or a communication processor (CP). The processor 120 may, for example, execute computation or data processing related to control and/or communication of at least one other component of the electronic device 101.

The memory 130 may include a volatile memory and/or a non-volatile memory. The memory 130 may, for example, store instructions or data related to at least one other component. According to an embodiment, the memory 130 may store software and/or programs 140. The programs 140 may include, for example, a kernel 141, middleware 143, an application programming interface (API) 145, and/or application programs (or applications) 147. At least a part of the kernel 141, the middleware 143, and the API 145 may be called an operating system (OS). The kernel 141 may control or manage system resources (for example, the bus 110, the processor 120, or the memory 130) that are used in executing operations or functions implemented in other programs such as the middleware 143, the API 145, or the application programs 147. Also, the kernel 141 may provide an interface for allowing the middleware 143, the API 145, or the application programs 147 to access individual components of the electronic device 101 and control or manage system resources.

The middleware 143 may serve as a medium through which the kernel 141 may communicate with, for example, the API 145 or the application programs 147 to transmit and receive data. Also, the middleware 143 may process one or more task requests received from the application programs 147 according to their priority levels. For example, the middleware 143 may assign priority levels for using system resources (the bus 110, the processor 120, or the memory 130) of the electronic device 101 to at least one of the application programs 147, and process the one or more task requests according to the priority levels. The API 145 is an interface that may control functions that the application programs 147 provide at the kernel 141 or the middleware 143. For example, the API 145 may include at least one interface or function (for example, a command) for file control, window control, video processing, or text control. The I/O interface 150 may, for example, provide a command or data received from a user or an external device to the other component(s) of the electronic device 101. Further, the I/O interface 150 may output a command or data received from the other component(s) of the electronic device 101 to the user or the external device.

The display 160 may include, for example, a liquid crystal display (LCD), a light emitting diode (LED) display, an organic LED (OLED) display, a microelectromechanical systems (MEMS) display, or an electronic paper display. The display 160 may display, for example, various types of content (for example, text, an image, a video, an icon, and/or a symbol) to the user. The display 160 may include a touch screen and receive, for example, a touch input, a gesture input, a proximity input, or a hovering input through an electronic pen or a user's body part. The communication interface 170 may establish communication, for example, between the electronic device 101 and an external device (for example, a first external electronic device 102, a second external electronic device 104, or a server 106). For example, the communication interface 170 may be connected to a network 162 by wireless communication or wired communication and communicate with the external device (for example, the second external electronic device 104 or the server 106) over the network 162.

The wireless communication may be conducted using, for example, at least one of long term evolution (LTE), LTE-advanced (LTE-A), code division multiple access (CDMA), wideband CDMA (WCDMA), universal mobile telecommunication system (UMTS), wireless broadband (WiBro), or global system for mobile communications (GSM), as a cellular communication protocol. According to an embodiment, the wireless communication may be conducted by, for example, at least one of wireless fidelity (WiFi), Bluetooth® (BT), Bluetooth® low energy (BLE), Zigbee®, near field communication (NFC), magnetic secure transmission, Radio Frequency (RF), or a body area network (BAN). According to an embodiment, the wireless communication may be conducted by GNSS. GNSS may include, for example, at least one of global positioning system (GPS), global navigation satellite system (Glonass®), Beidou® navigation satellite system (hereinafter, referred to as ‘Beidou’), or Galileo®, the European global satellite-based navigation system. In the present disclosure, the terms ‘GPS’ and ‘GNSS’ are interchangeably used with each other. The wired communication may be conducted in conformance to, for example, at least one of universal serial bus (USB), high definition multimedia interface (HDMI), recommended standard 232 (RS-232), power line communication, or plain old telephone service (POTS). The network 162 may be a telecommunication network, for example, at least one of a computer network (for example, local area network (LAN) or wide area network (WAN)), the Internet, or a telephone network.

Each of the first and second external electronic devices 102 and 104 may be of the same type as or a different type from the electronic device 101. According to various embodiments, all or a part of operations performed in the electronic device 101 may be performed in one or more other electronic devices (for example, the electronic devices 102 and 104) or the server 106. According to an embodiment, if the electronic device 101 is to perform a function or a service automatically or upon request, the electronic device 101 may request at least a part of functions related to the function or the service to another device (for example, the electronic device 102 or 104 or the server 106), instead of performing the function or the service autonomously, or additionally. The other electronic device (for example, the electronic device 102 or 104 or the server 106) may execute the requested function or an additional function and provide a result of the function execution to the electronic device 101. The electronic device 101 may provide the requested function or service based on the received result or by additionally processing the received result. For this purpose, for example, cloud computing, distributed computing, or client-server computing may be used.

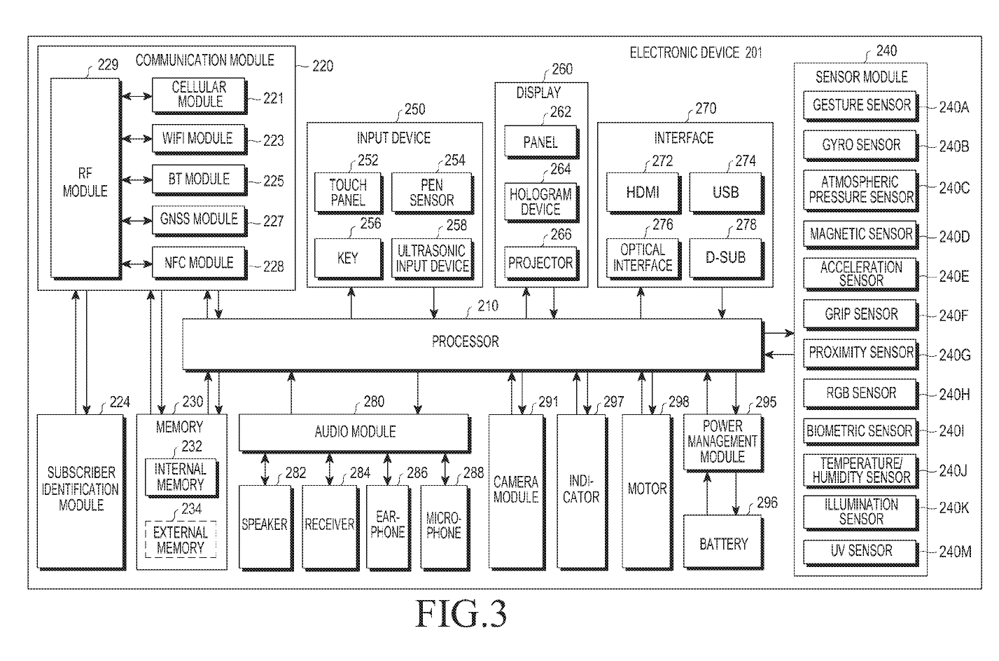

FIG. 3 is a block diagram of an electronic device according to various embodiments.

Referring to FIG. 3, the electronic device 201 may include, for example, the whole or part of the electronic device 101 illustrated in FIG. 2. The electronic device 201 may include at least one processor (for example, AP) 210, a communication module 220, a subscriber identification module (SIM) 224, a memory 230, a sensor module 240, an input device 250, a display 260, an interface 270, an audio module 280, a camera module 291, a power management module 295, a battery 296, an indicator 297, and a motor 298. The processor 210 may, for example, control a plurality of hardware or software components that are connected to the processor 210 by executing an OS or an application program and may perform processing or computation of various types of data. The processor 210 may be implemented, for example, as a system on chip (SoC). According to an embodiment, the processor 210 may further include a graphics processing unit (GPU) and/or an image signal processor. The processor 210 may include at least a part (for example, a cellular module 221) of the components illustrated in FIG. 3. The processor 210 may load a command or data received from at least one of other components (for example, a non-volatile memory), process the loaded command or data, and store various types of data in the non-volatile memory.

The communication module 220 may have the same configuration as or a similar configuration to the communication interface 170. The communication module 220 may include, for example, the cellular module 221, a WiFi module 223, a Bluetooth (BT) module 225, a GNSS module 227, or an NFC module 228. The SIM 224 may include, for example, a card including the SIM or an embedded SIM. The SIM 224 may include a unique identifier (for example, integrated circuit card identifier (ICCID)) or subscriber information (for example, international mobile subscriber identity (IMSI)).

The memory 230 (for example, the memory 130) may include, for example, an internal memory 232 or an external memory 234. The internal memory 232 may be at least one of, for example, a volatile memory (for example, dynamic RAM (DRAM), static RAM (SRAM), or synchronous dynamic RAM (SDRAM)), and a non-volatile memory (for example, one-time programmable ROM (OTPROM), programmable ROM (PROM), erasable and programmable ROM (EPROM), electrically erasable and programmable ROM (EEPROM), mask ROM, flash ROM, flash memory, a hard drive, or a solid state drive (SSD). The external memory 234 may include a flash drive such as a compact flash (CF) drive, a secure digital (SD), a micro secure digital (micro-SD), a mini secure digital (mini-SD), an extreme digital (xD), a multi-media card (MMC), or a memory stick. The external memory 234 may be operatively or physically coupled to the electronic device 201 via various interfaces.

The sensor module 240 may, for example, measure physical quantities or detect operational states of the electronic device 201, and convert the measured or detected information into electric signals. The sensor module 240 may include at least one of, for example, a gesture sensor 240A, a gyro sensor 240B, an atmospheric pressure sensor 240C, a magnetic sensor 240D, an accelerometer sensor 240E, a grip sensor 240F, a proximity sensor 240G, a color sensor (for example, a red, green, blue (RGB) sensor) 240H, a biometric sensor 2401, a temperature/humidity sensor 240J, an illumination sensor 240K, or an ultra violet (UV) sensor 240M. Additionally or alternatively, the sensor module 240 may include, for example, an electrical-nose (E-nose) sensor, an electromyogram (EMG) sensor, an electroencephalogram (EEG) sensor, an electrocardiogram (ECG) sensor, an infrared (IR) sensor, an iris sensor, and/or a finger print sensor. The sensor module 240 may further include a control circuit for controlling one or more sensors included therein. According to some embodiments, the electronic device 201 may further include a processor configured to control the sensor module 240, as a part of or separately from the processor 210. Thus, while the processor 210 is in a sleep state, the control circuit may control the sensor module 240.

The input device 250 may include, for example, a touch panel 252, a (digital) pen sensor 254, a key 256, or an ultrasonic input device 258. The touch panel 252 may operate in at least one of, for example, capacitive, resistive, infrared, and ultrasonic schemes. The touch panel 252 may further include a control circuit. The touch panel 252 may further include a tactile layer to thereby provide haptic feedback to the user. The (digital) pen sensor 254 may include, for example, a detection sheet which is a part of the touch panel or separately configured from the touch panel. The key 256 may include, for example, a physical button, an optical key, or a keypad. The ultrasonic input device 258 may sense ultrasonic waves generated by an input tool using a microphone (for example, a microphone 288), and identify data corresponding to the sensed ultrasonic waves.

The display 260 (for example, the display 160) may include a panel 262, a hologram device 264, a projector 266, and/or a control circuit for controlling these components. The panel 262 may be configured to be, for example, flexible, transparent, or wearable. The panel 262 and the touch panel 252 may be implemented as a single module. The hologram device 264 may utilize the interference of light waves to provide a three-dimensional image in empty space. The projector 266 may display an image by projecting light on a screen. The screen may be positioned, for example, inside or outside the electronic device 201. The interface 270 may include, for example, an HDMI 272, a USB 274, an optical interface 276, or a D-subminiature (D-SUB) 278. The interface 270 may be included, for example, in the communication interface 170 illustrated in FIG. 2. Additionally or alternatively, the interface 270 may include, for example, a mobile high-definition link (MHL) interface, an SD/multimedia card (MMC) interface, or an infrared data association (IrDA) interface.

The audio module 280 may, for example, convert a sound to an electrical signal, and vice versa. At least a part of the components of the audio module 280 may be included, for example, in the I/O interface 150 illustrated in FIG. 2. The audio module 280 may process sound information input into, or output from, for example, a speaker 282, a receiver 284, an earphone 286, or the microphone 288. The camera module 291 may capture, for example, still images and a video. According to an embodiment, the camera module 291 may include one or more image sensors (for example, a front sensor or a rear sensor), a lens, an image signal processor (ISP), or a flash (for example, an LED or a xenon lamp). The power management module 295 may manage power of, for example, the electronic device 201. According to an embodiment, the power management module 295 may include a power management integrated circuit (PMIC), a charger IC, or a battery or fuel gauge. The PMIC may adopt wired and/or wireless charging. The wireless charging may be performed, for example, in a magnetic resonance scheme, a magnetic induction scheme, or an electromagnetic wave scheme, and may further include an additional circuit for wireless charging, for example, a coil loop, a resonance circuit, or a rectifier. The battery gauge may measure, for example, a charge level, a voltage while charging, current, or temperature of the battery 296. The battery 296 may include, for example, a rechargeable battery and/or a solar battery.

The indicator 297 may indicate specific states of the electronic device 201 or a part of the electronic device 201 (for example, the processor 210), for example, boot status, message status, or charge status. The motor 298 may convert an electrical signal into a mechanical vibration and generate vibrations or a haptic effect. The electronic device 201 may include a mobile TV processing device (for example, a GPU) capable of processing media data compliant with, for example, digital multimedia broadcasting (DMB), digital video broadcasting (DVB), or MediaFLO™. Each of the above-described components of the electronic device may include one or more parts and the name of the component may vary with the type of the electronic device. According to various embodiments, some component may be omitted from or added to the electronic device (for example, the electronic device 201), or one entity may be configured by combining a part of the components of the electronic device, to thereby perform the same functions of the components prior to the combining.

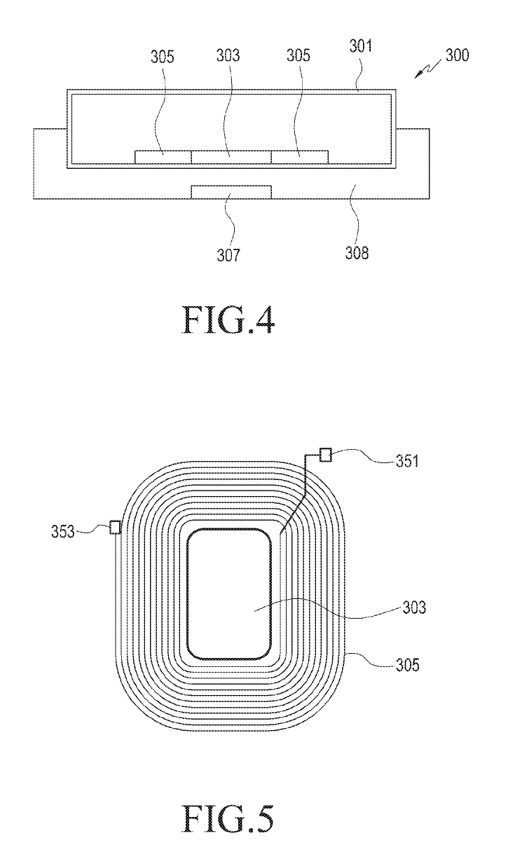

FIG. 4 is a sectional view illustrating an electronic device engaged with an accessory according to one of various embodiments of the present disclosure, and FIG. 5 is a plan view illustrating a conductive pattern and a first member in an electronic device according to one of various embodiments of the present disclosure.

Referring to FIGS. 4 and 5, an electronic device 300 according to various embodiments of the present disclosure may include a housing 301, a conductive pattern 305, a first member 303, a first cover 308, and a second member 307. The first cover 308 and the second member 307 may collectively form an accessory device which may be detachably engaged with the electronic device 300.

The housing 301 may include a first surface facing in a first direction, and a second surface facing in a second direction opposite to the first direction. The first and second surfaces of the housing 301 may be flat and parallel to each other. However, the first and second surfaces are not limited to a flat shape. Rather, the first surface or the second surface may be partially curved.

The conductive pattern 305 may be disposed on the second surface of the housing 301. The conductive pattern 305 may be shaped into a flat coil, and generate current by external electromagnetic induction. The conductive pattern 305 may include a first connection terminal 351 at one end and a second connection terminal 353 at the other end. The first and second connection terminals 351 and 353 may be connected electrically to the circuit board (15 in FIG. 1). The current generated from the conductive pattern 305 may charge the battery (14 in FIG. 1) through the circuit board. The conductive pattern 305 may be controlled by a charging circuit (for example, a charger IC) included in the power management module (295 in FIG. 3).

According to an embodiment, the first member 303 may be positioned at the center of the conductive pattern 305, for example, between separated portions of the conductive pattern 305. As the wire of the conductive pattern 305 is extended spirally, the conductive pattern 305 may be shaped into a flat coil, and one portion of the conductive pattern 305 may be apart from the other portion of the conductive pattern 305. A space may be defined between the one portion and the other portion of the conductive pattern 305. The first member 303 may be disposed in the space. When seen from above the housing 301, the first member 303 may be disposed substantially at the center of the housing 301. The first member 303 may contain a material attracted to a magnetic body or a magnet. For example, the first member 303 may be a magnetic body or a magnet. According to an embodiment, the first member 303 may be formed of an amorphous metallic material. For example, the amorphous metallic material may be an Fe-based amorphous alloy, a Co-based amorphous alloy, or a nanocrystalline alloy. The Fe-based amorphous alloy may be an Fe—Si—B alloy or an Fe—Si—B—Co alloy. The nanocrystalline alloy may be an Fe—Si—B—Cu—Nb alloy. Since the amorphous metallic material may be less magnetic than a general magnet, the amorphous metallic material may reduce obstruction of electromagnetic induction to the conductive pattern 305. According to various embodiments of the present disclosure, since a shield member is further provided to surround the first member 303, obstruction of electromagnetic induction to the conductive pattern, caused by the first member 303 may be reduced.

The first cover 308 may protect the housing 301 from an external impact by covering at least a part of the second surface of the housing 301. The first cover 308 may be formed of various materials such as plastic, natural leather, or artificial leather. The first cover 308 may be detachably engaged with the housing 301. For example, as the first cover 308 is formed of a flexible material, the housing 301 may be engaged with the first cover 308 through insertion. According to various embodiments of the present disclosure, the first cover 308 is not limited to covering the second surface of the housing 301. Rather, the first cover 308 may be detachably engaged with at least one of the first surface or second surface of the housing 301.

When seen from above the housing 301, the second member 307 may be overlapped at least partially with the first member 303 and provided on the first cover 308, apart from the first member 303 in the first or second direction. The second member 307 may contain a material attracted to a magnetic body or a magnet. For example, the second member 307 may be a magnetic body or a magnet. The second member 307 may be formed of an amorphous metallic material. Since the amorphous metallic material may be less magnetic than a general magnet, the amorphous metallic material may reduce obstruction of electromagnetic induction to the conductive pattern 305.

An operation for wirelessly charging the electronic device 300 including the conductive pattern 305, the first member 303, and the second member 307 will be described later with reference to the drawings.

According to various embodiments of the present disclosure, a portable electronic device may include a housing having a first surface facing in a first direction, and a second surface facing in a second direction opposite to the first direction, a conductive pattern provided inside the housing, a first member provided between separated portions of the conductive pattern and containing a material attracted to a magnetic body or a magnet, a second member overlapped at least partially with the first member, when seen from above the housing, apart from the first member in the first or second direction, and containing a material attracted to a magnetic body or a magnet, and a circuit connected electrically to the conductive pattern. The circuit may be configured to wirelessly receive external power using the conductive pattern.

According to various embodiments of the present disclosure, the first member or the second member may contain an amorphous metallic material.

According to various embodiments of the present disclosure, the amorphous metallic material may be an Fe-based amorphous alloy, a Co-based amorphous alloy, or a nanocrystalline alloy.

According to various embodiments of the present disclosure, the Fe-based amorphous alloy may be an Fe—Si—B alloy or an Fe—Si—B—Co alloy.

According to various embodiments of the present disclosure, the nanocrystalline alloy may be an Fe—Si—B—Cu—Nb alloy.

According to various embodiments of the present disclosure, the first member and the second member may be formed of the same material.

According to various embodiments of the present disclosure, the first member or the second member may be disposed substantially at the center of the housing, when seen from above the housing.

According to various embodiments of the present disclosure, the electronic device may further include a first cover for covering at least a part of the second surface of the housing, and the second member may be disposed on the first cover.

According to various embodiments of the present disclosure, the first cover may be detachably engaged with the housing.

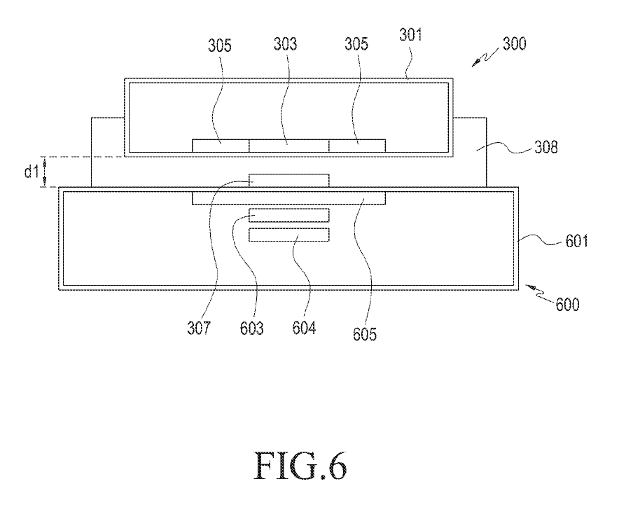

FIG. 6 is a sectional view illustrating an electronic device engaged with an accessory, which has been placed on a wireless charger according to one of various embodiments of the present disclosure.

Referring to FIG. 6, a wireless charger 600 according to an embodiment may include a housing 601, a second conductive pattern 605, a magnetic body 603, and a sensor 604, and the electronic device 300 engaged with the accessory 308 may be placed on one surface of the housing 601 of the wireless charger 600.

The second conductive pattern 605 may be formed into a flat coil, in correspondence with the conductive pattern 305. The second conductive pattern 605 may generate an electromagnetic field by receiving current. When the conductive pattern 305 is positioned within the electromagnetic field generated by the second conductive pattern 605, the conductive pattern 305 may receive induced current by the electromagnetic field.

A second space may be formed in the second conductive pattern 605, in correspondence with the space of the conductive pattern 305, and the magnetic body 603 may be positioned in correspondence with the second space. The magnetic body 603 may be a general magnet. The magnetic body 603 may align the conductive pattern 305 with the second conductive pattern 605 by attracting the second member 307. Owing to the alignment between the conductive pattern 305 and the second conductive pattern 605, the efficiency of electromagnetic coupling between the second conductive pattern 605 and the conductive pattern 305 may be increased. For example, the efficiency of wireless power transmission from the wireless charger 600 to the electronic device 300 may be increased.

The sensor 604 may sense a variation in magnetic flux around the sensor 604. For example, as the second member 307 becomes close to the sensor 604 during arrangement of the electronic device 300 on the housing 601 of the wireless charger 600, the magnetic flux around the sensor 604 may be changed. An electrical signal may be generated from the sensor 604 as a result of the variation of the magnetic flux around the sensor 604, and provided to a controller (not shown) of the housing 601 of the wireless charger 600. If the electrical signal is outside a predetermined range (for example, the range of an electrical signal generated from the sensor 604 before the magnetic flux is changed by the second member 307), the controller may control application of current to the second conductive pattern 605, determining that the electronic device 300 has been placed on the wireless charger 600.

According to various embodiments of the present disclosure, the first cover 308 may be separated from the housing 301 and thus the second surface of the electronic device 300 may contact the wireless charger 600. As the first member 303 gets close to the sensor 604, the sensor 604 may generate current due to a variation in the magnetic flux, caused by the first member 303. The current may be provided to the controller, and the controller may control application of the current to the second conductive pattern 605. However, in a state where the first cover 308 is engaged with the housing 301, covering the second surface of the housing 301, an attractive force between the first member 303 and the magnetic body 603 may be blocked by the first cover 308, or the sensor 604 may not sense the first member 303 due to the first cover 308. For example, the sensor 604 may not sense the first member 303 according to the thickness dl or material of the first cover 308.

Therefore, since the electronic device 300 according to one of various embodiments of the present disclosure is provided with the second member 307 on the first cover 308, a magnetic force of the second member 307 may reach the sensor 604 even though a magnetic force of the first member 303 is blocked by the first cover 308.

Meanwhile, if the electronic device 300 is removed from the wireless charger 600 (for example, if current that the controller receives from the sensor 604 is inside the predetermined range), the controller may block application of current to the second conductive pattern 605, determining the absence of the electronic device 300 on the housing 601 of the wireless charger 600.

Now, a description will be given of an operation for wirelessly charging the electronic device 300 according to one of various embodiments of the present disclosure.

The sensor 604 may sense whether the electronic device 300 has been appropriately arranged on the housing 601 of the wireless charger 600.

If the electronic device 300 has been appropriately arranged on the housing 601 of the wireless charger 600, the controller may apply current to the second conductive pattern 605, and thus the second conductive pattern 605 may generate an electromagnetic field.

The conductive pattern 305 of the electronic device 300 may receive induced current by the electromagnetic field (for example, the electromagnetic field generated by the second conductive pattern 605).

The power management module (295 in FIG. 3) may apply charging current to the battery (14 in FIG. 1) using the induced current generated by the conductive pattern 305. An operation for wirelessly charging the electronic device 300 by the wireless charger 600 will be described later in greater detail with reference to the drawings.

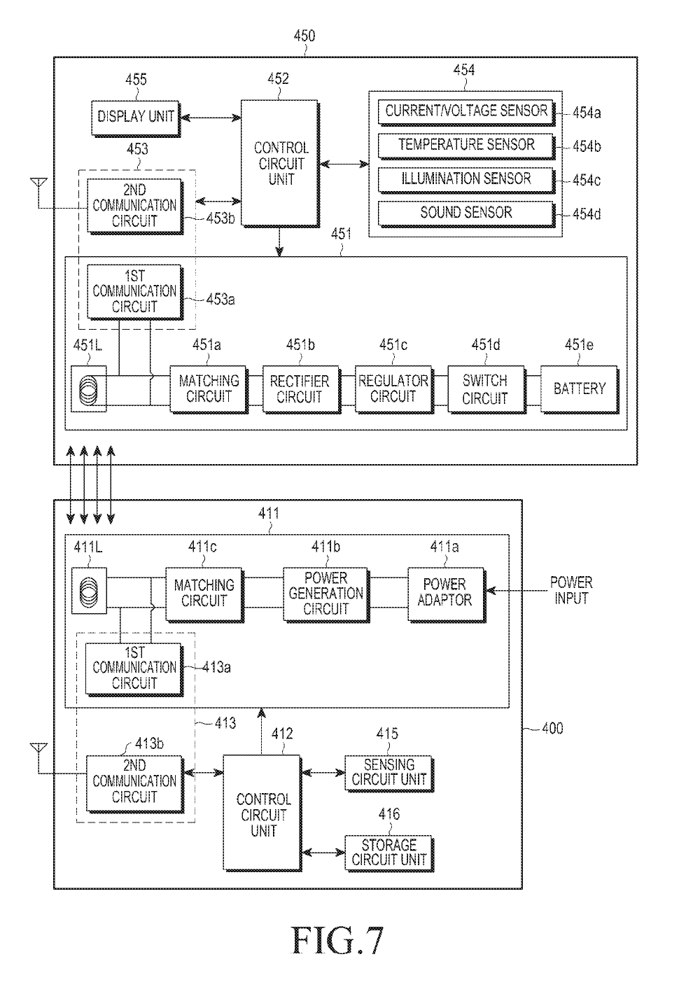

FIG. 7 is a block diagram of a wireless charging system according to various embodiments of the present disclosure.

Referring to FIG. 7, a wireless charging system according to an embodiment of the present disclosure may include an external electronic device 400 for transmitting wireless power, and an electronic device 450 for receiving the transmitted wireless power. The external electronic device 400 may include the whole or part of the wireless charger 600 illustrated in FIG. 6. The electronic device 450 may include the whole or part of the electronic device 300 illustrated in FIG. 6. The external electronic device 400 (for example, the wireless charger 600) according to an embodiment of the present disclosure may include a power transmission circuit unit 411, a control circuit unit 412, a communication circuit unit 413, a sensing circuit unit 415, and a storage circuit unit 416. The electronic device 450 may include a power reception circuit unit 451, a control circuit unit 452, a communication circuit unit 453, a sensing circuit unit 454, and a display unit 455.

The power transmission circuit unit 411 may supply power required for the electronic device 450 which wants to receive power, and include a loop coil 411L formed into a conductive pattern. The power transmission circuit unit 411 may supply power wirelessly to the electronic device 450 through the loop coil 411L. The power transmission circuit unit 411 may receive power in the form of a direct current (DC) or alternating current (AC) waveform from the outside, and supply the received power in the form of an AC waveform to the electronic device 450. For example, if the power transmission circuit unit 411 receives power in a DC waveform, the power transmission circuit unit may convert the DC-waveform power to an AC waveform by means of an inverter and supply the AC-waveform power to the electronic device 405, which should not be construed as limiting the power transmission circuit unit 411. As far as it can supply power in a predetermined AC waveform, any means is available as the power transmission circuit unit 411.

Further, the power transmission circuit unit 411 may supply an AC waveform in the form of electromagnetic waves to the electronic device 450. The power transmission circuit unit 411 may include the loop coil 411L formed into a conductive pattern. As current is applied to the loop coil 411L, predetermined electromagnetic waves may be generated from the loop coil 411L, and the power transmission circuit unit 411 may transmit or receive the electromagnetic waves by electromagnetic induction or resonance. The power transmission circuit unit 411 may further include a first communication circuit 413a (for example, a resonant circuit), and conduct communication (for example, data communication) in an in-band manner through the first communication circuit 413a, using the electromagnetic waves generated from the loop coil 411L. A detailed description will be given later of the first communication circuit 413a in relation to the later-descried communication circuit unit 413. If the power transmission unit 411 is configured with a resonant circuit, it may be possible to change the inductance L of the loop coil 411L in the resonant circuit.

Also, the power transmission circuit unit 411 may be configured as a built-in battery or a power reception interface, to thereby receive external power and supply the power to other components.

The power transmission circuit unit 411 may further include, for example, a power adaptor 411a, a power generation circuit 411b, and a matching circuit 411c, in addition to the loop coil 411L.

The power adaptor 411a may receive external AC or DC power or a power signal from a battery device and output the received power or power signal as DC power having a predetermined voltage value. The voltage value of the DC power output from the power adaptor 411a may be controlled by the control circuit unit 412. The DC power output from the power adaptor 411a may be provided to the power generation circuit 411b.

The power generation circuit 411b may convert the DC current received from the power adaptor 411a to AC current. The power generation circuit 411b may include a predetermined amplifier (not shown). If the gain of the DC current received from the power adaptor 411a is less than a predetermined gain, the power generation circuit 411b may amplify the DC current to a predetermined gain using the amplifier. Also, the power generation circuit 411b may further include a circuit for converting the DC current received from the power adaptor 411a to AC current based on a control signal received from the control circuit unit 412. For example, the power generation circuit 411b may convert the DC current to the AC current by means of a predetermined inverter. Or the power generation circuit 411b may further include a gate driver (not shown), and the gate driver may convert the DC current to the AC current, while controlling on/off of the DC current. Or the power generation circuit 411b may generate an AC power signal through a wireless power generator (for example, an oscillator). Thus, the power generation circuit 411b may output the AC power.

The matching circuit 411c may perform impedance matching. For example, if the AC signal output from the power generation circuit 411b is provided to the loop coil 411L, an electromagnetic field may be generated in the loop coil 411L by the AC signal. Herein, the matching circuit 411c may adjust impedance viewed from the matching circuit 411c by adjusting the frequency band of a signal of the generated electromagnetic field. The matching circuit 411c may control output of high-efficiency, high output power to the electronic device 450 through the loop coil 411L by adjusting, for example, the impedance viewed from the matching circuit 411c in this manner. The matching circuit 411c may adjust impedance under the control of the control circuit unit 412. The matching circuit 411c may include at least one of an inductor (for example, a coil), a capacitor, and a switch. The control circuit unit 412 may control the state of a connection to at least one of the inductor and the capacitor through the switch, thus performing impedance matching.

Those skilled in the art will understand that the power transmission circuit unit 411 is not limited to the above configuration, and any means is available as the power transmission circuit unit 411 as far as it is capable of transmitting and receiving electromagnetic waves.

The sensing circuit unit 415 (for example, the sensor module 240) may sense a variation in current/voltage applied to the loop coil 411L of the power transmission circuit unit 411. The external electronic device 400 may generate as much transmission power as determined according to the magnitude of the current/voltage applied to the loop coil 411L. That is, the external electronic device 400 may change the amount of transmission power according to a variation in current/voltage applied to the loop coil 411L. For example, as the magnitude of current/voltage applied to the loop coil 411L increases, the amount of transmission power may increase, and as the magnitude of current/voltage applied to the loop coil 411L decreases, the amount of transmission power may decrease. Further, the sensing circuit unit 415 may sense a variation in temperature of the external electronic device 400. The sensing circuit unit 415 may sense a temperature change that may occur in the external electronic device 400 when the power transmission circuit unit 411 generates transmission power or transmits the generated power to the electronic device 450. For example, the sensing circuit unit 415 may measure at least one of internal temperature and ambient temperature of the external electronic device 400. According to an embodiment, the sensing circuit unit 415 may include at least one of a current/voltage sensor and a temperature sensor.

The control circuit unit 412 may provide overall control to the external electronic device 400. The control circuit unit 412 may control overall operations of the external electronic device 400 using an algorithm, a program, or an application required for the control, which is stored in the storage circuit unit 416. Also, the control circuit unit 412 may control wireless power transmission to the electronic device 450 through the power transmission circuit 411. The control circuit unit 412 may control wireless information reception from the electronic device 450 through the communication circuit unit 413.

The communication circuit unit 413 (the first communication circuit 413a and/or a second communication circuit 413b) (for example, the communication interface 170 or the communication module 220) may communicate with the electronic device 450 in a predetermined scheme. The communication circuit unit 413 may conduct data communication with the communication circuit unit 453 of the electronic device 450.

Meanwhile, the communication circuit unit 413 may transmit a signal of information about the external electronic device 400 to the electronic device 450. The communication circuit unit 413 may unicast, multicast, or broadcast the signal. Further, the communication circuit unit 413 may transmit a charging function control signal for controlling the charging function of the electronic device 450. The charging function control signal may be a control signal that enables or disables the charging function by controlling the power reception circuit unit 451 of a specific electronic device (for example, the electronic device 450).

Meanwhile, the communication circuit unit 413 may transmit or receive a signal to or from another wireless power transmission apparatus (not shown) as well as the electronic device 450.

According to an embodiment of the present disclosure, the communication circuit unit 413 may include, for example, at least one of the first communication circuit 413a that may be incorporated with the power transmission circuit unit 411 in one hardware unit and enable the external electronic device 400 to communicate in an in-band manner, and the second communication circuit 413b that may be configured in hardware separate from the power transmission circuit unit 411 and enable the external electronic device 400 to communicate in an out-of-band manner.

For example, if the communication circuit unit 413 includes the first communication circuit 413a capable of in-band communication, the first communication circuit 413a may receive the frequency and signal level of an electromagnetic field signal from the loop coil 411L of the power transmission circuit unit 411. The control circuit unit 412 may extract information received from the electronic device 450 by decoding the received frequency and signal level of the electromagnetic field signal. Also, the first communication circuit 413a may apply a signal of information about the external electronic device 400 to be transmitted to the electronic device 450, to the loop coil 411L of the power transmission circuit unit 411, or may add the signal of the information about the external electronic device 400 to an electromagnetic field signal generated by applying a signal output from the matching circuit 411c to the loop coil 411L. The control circuit unit 412 may control the signal output by changing the connection state of at least one of the inductor and the capacitor of the matching circuit 411c through on/off control of the switch included in the matching circuit 411c.

For example, if the communication circuit unit 413 includes the second communication circuit 413b capable of out-of-band communication, the second communication circuit 413b may communicate with the communication circuit unit 453 (for example, a second communication circuit 453b) of the electronic device 450 by NFC, Zigbee, IR communication, visible ray communication. Bluetooth®, BLE, or the like.

However, the above-described communication scheme of the communication circuit unit 413 is purely exemplary, and thus the scope of the embodiments of the present disclosure is not limited to the specific communication scheme of the communication circuit unit 413.

Further, the communication circuit unit 413 may transmit a charging function control signal for controlling the charging function of the electronic device 450. The charging function control signal may be a control signal that enables or disables the charging function by controlling the power reception circuit unit 451 of the electronic device 450.

The communication circuit unit 413 may transmit or receive a signal to or from another wireless power transmission apparatus (not shown) as well as the electronic device 450. While the communication circuit unit 413 is shown in FIG. 7 as configured separately in hardware from the power transmission circuit unit 411 and enabling the external electronic device 400 to conduct out-of-band communication, this is purely exemplary. In the present disclosure, the power transmission circuit unit 411 and the communication circuit unit 413 may be incorporated into a single hardware unit so that the external electronic device 400 may conduct in-band communication.

The external electronic device 400 and the electronic device 450 may transmit and receive signals to and from each other through their communication circuit units 413 and 453.

According to various embodiments of the present disclosure, the external electronic device 400 may be a portable terminal including the power transmission circuit unit 411 and a battery. Accordingly, the external electronic device 400 being a portable terminal may wirelessly transmit power stored in the battery to the electronic device 450. According to various embodiments of the present disclosure, the external electronic device 400 may be one of various electronic devices including the power transmission circuit unit 411, not limited to a portable terminal.

Meanwhile, the power reception circuit unit 451 of the electronic device 450 according to an embodiment of the present disclosure may receive power from the power transmission circuit unit 411 of the external electronic device 400. Or the power reception circuit unit 451 may be configured as a built-in battery or a power reception interface to receive external power. The power reception circuit unit 451 may include a loop coil 451L formed in a conductive pattern. The power reception circuit unit 451 may receive wireless power in the form of electromagnetic waves generated in correspondence with current/voltage applied to the loop coil 411L of the power transmission circuit unit 411 through the loop coil 451L. For example, the power reception circuit unit 451 may receive, from the power transmission circuit unit 411, power which has been induced from AC-waveform power applied to the loop coil 411L of the power transmission circuit unit 411 and then supplied to the loop coil 451L of the power reception circuit unit 451 adjacent to the power transmission circuit unit 411. For example, the power reception circuit unit 451 may receive wireless power in the form of electromagnetic waves generated in correspondence with current/voltage applied to the loop coil 411L of the power transmission circuit unit 411 through the loop coil 451L.

The power reception circuit unit 451 may further include, for example, a matching circuit 451a, a rectifier circuit 451b, a regulator circuit 451c, a switch circuit 451d, and a battery 451e, in addition to the loop coil 451L.

The matching circuit 451a may perform impedance matching. For example, power transmitted through the loop coil 411L of the external electronic device 400 may be transferred to the loop coil 451L, thus generating an electromagnetic field. The matching circuit 451a may adjust impedance viewed from the matching circuit 451a by adjusting the frequency band of a signal of the generated electromagnetic field. The matching circuit 451a may control input power received from the external electronic device 400 through the loop coil 451L to be highly efficient and have high output power through impedance matching. The matching circuit 451a may adjust the impedance under control of the control circuit unit 452. The matching circuit unit 451a may include at least one of an inductor (for example, a coil), a capacitor, and a switch. The control circuit unit 452 may control the state of a connection to at least one of the inductor and the capacitor through the switch, and thus impedance matching may be performed accordingly.

The rectifier circuit 451b may rectify wireless power received at the loop coil 451L to DC power. For example, the rectifier circuit 451b may be configured as a bridge diode.

The regulator circuit 451c may convert the rectified power to have a predetermined gain. The regulator circuit 451c may include a predetermined DC/DC converter (not shown). For example, the regulator circuit 451c may convert the rectified power in such a manner that a voltage at its output end may become 5V. Meanwhile, upper and lower values of a voltage that may be applied to a front end of the regulator circuit 451c may be predetermined.

The switch circuit 451d may connect the regulator circuit 451c to the battery 451e. The switch circuit 451d may be kept on or off under the control of the control circuit unit 452.

If the switch circuit 451d is in an on state, the battery 451e may be charged by receiving power from the regulator circuit 451c.

The sensing circuit unit 454 may sense a change of the charging state of power received at the electronic device 450. For example, the sensing circuit unit 454 may periodically or aperiodically measure a current/voltage value received at the loop coil 451L through a predetermined current/voltage sensor 454a. The electronic device 450 may calculate the amount of its received power based on the current/voltage measurement.

The sensing circuit unit 454 may sense a change in the charging environment of the electronic device 450. For example, the sensing circuit unit 454 may periodically or aperiodically measure at least one of the internal temperature and ambient temperature of the electronic device 450 through a predetermined temperature sensor 454b. The sensing circuit unit 454 may periodically or aperiodically measure ambient illuminance (brightness) of the electronic device 450 through a predetermined illumination sensor 454c. The sensing circuit unit 454 may periodically or aperiodically measure the level of sound (noise) around the electronic device 450.

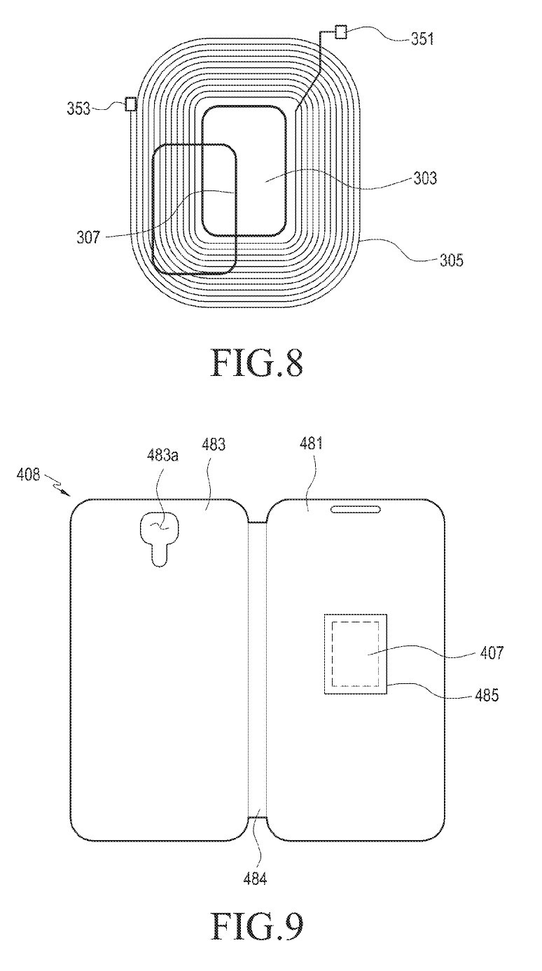

FIG. 8 is a plan view illustrating a second member partially overlapped with a conductive pattern according to various embodiments of the present disclosure.

Referring to FIG. 8, if the second member 307 is partially overlapped with the conductive pattern 305, the resulting misalignment between the conductive pattern 305 and the second conductive pattern (605 in FIG. 6) may decrease the efficiency of electromagnetic induction from the second conductive pattern (605 in FIG. 6). Therefore, the second member 307 according to one of various embodiments of the present disclosure may be disposed at a position corresponding to the first member 303, for example, substantially at the center of the conductive pattern 305, when seen from above the housing (301 in FIG. 6), thereby aligning the conductive pattern 305 with the second conductive pattern (605 in FIG. 6). Owing to the alignment between the conductive pattern 305 and the second conductive pattern (605 in FIG. 6), the efficiency of electromagnetic coupling between the conductive pattern 305 and the second conductive pattern 605 may be increased.

Meanwhile, even though the second member 307 is attracted to the magnetic body (603 in FIG. 6), if the conductive pattern 305 is not aligned with the second conductive pattern 605, the wireless charging efficiency of the conductive pattern 305 may be decreased. To avert this problem, the processor (120 in FIG. 2) of the electronic device (for example, the electronic device 101 in FIG. 2 or 300 in FIG. 6) according to various embodiments of the present disclosure may determine the efficiency of wireless charging. The processor may determine the wireless charging efficiency by comparing the amount of received power with a predetermined power amount (for example, the amount of power in the case of alignment between the conductive pattern and the second conductive pattern). Also, the electronic device (300 in FIG. 6) according to various embodiments of the present disclosure may include a second sensor that measures heat emitted from the conductive pattern 305. The second sensor may be disposed in the vicinity of the conductive pattern 305, measure heat emitted from the conductive pattern 305, and provide information about the heat measurement to the processor. The processor may determine a wireless charging efficiency by comparing the heat measured by the second sensor with a predetermined heat amount (for example, the amount of heat in the case of alignment between the conductive pattern and the second conductive pattern).

The processor may determine whether the conductive pattern 305 of the electronic device 300 is aligned with the second conductive pattern 605 of the wireless charger 600 by determining the wireless charging efficiency.

If the wireless charging efficiency is low (for example, if the amount of the received power is smaller than the predetermined power amount), the processor may transmit an electrical signal to the display device of the electronic device so that an image (for example, an image indicating misalignment of the electronic device on the wireless charger) may be displayed on the display device of the electronic device. Or the processor may indicate misalignment between the electronic device and the wireless charger to a user by generating a voice signal in the electronic device. Or the processor may indicate misalignment between the electronic device and the wireless charger to a user by providing an electrical signal to a vibration motor that executes a haptic function of the electronic device and thus generating vibrations in the vibration motor.

FIG. 9 is a plan view illustrating an accessory device according to various embodiments of the present disclosure.

Referring to FIG. 9, an accessory device according to various embodiments of the present disclosure may include a cover unit 408, a second member 407, and an attachment portion 485.

The cover unit 408 may include a first cover 483 that covers at least a part of a second surface of an electronic device (for example, the rear surface portion 12a in FIG. 1 or the second surface of the electronic device 301 in FIG. 4), a second cover 481 that opens or closes at least a part of a first surface of the electronic device, and a connector 484 that connects the first cover 483 to the second cover 481. For example, the first cover 483 may be engaged with the electronic device, and the second cover 481 may open or close the first surface of the electronic device, while rotating around the connector 484 with respect to the first cover 483. A hole 483a may be formed on the first cover 483 in order to expose a camera module or a finger print recognition module provided on the second surface of the electronic device from the first cover 483.

The second member 407 may be provided on an outer surface of the second cover 481. The second cover 481 may open the first surface of the electronic device by rotating with respect to the first cover 483. With the first surface of the electronic device opened, the second cover 481 may face the first cover 483, on the second surface of the electronic device. If the electronic device is near over the wireless charger (600 in FIG. 6), the second member 407 may cause a variation in magnetic flux around the sensor (604 in FIG. 6). As the second cover 481 opens the first surface of the electronic device, the display panel (13b in FIG. 1) may display an image or a video on the first surface of the electronic device, and the second member 407 may be attracted by a magnetic force of the magnetic body (603 in FIG. 6). Thus, the second member 407 may align the conductive pattern (305 in FIG. 6) with the second conductive pattern (605 in FIG. 6). According to various embodiments of the present disclosure, the second member 407 may be attached to either of the inner and outer surfaces of the first cover 483. According to various embodiments, the second member 407 may be provided on both the first and second covers 483 and 481. For example, the second member 407 may be provided in at least a part of the inner or outer surface of the first cover 483 and at least a part of the inner or outer surface of the second cover 481.

According to various embodiments of the present disclosure, the attachment portion 485 may contain an adhesive and attach the second member 407 onto the second cover 481, surrounding the second member 407. According to various embodiments of the present disclosure, the attachment portion 485 may attach the second member 407 onto the first cover 483, not limited to attachment of the second member 407 onto the second cover 481. Therefore, even though the second member 407 is not provided inside of the first or second cover 483 or 481, the second member 407 may be provided on the first or second cover 483 or 481 by means of the attachment portion 485. In other words, the user may attach the second member 407 at the center of the existing housing (301 in FIG. 6) using the attachment portion 485, without separately purchasing an accessory device having the second member 407. Since the attachment portion 485 has a shielding property, the attachment portion 485 may change the magnetic strength of the second member 407.

According to various embodiments of the present disclosure, an accessory device detachably engaged with an electronic device having a first surface with a display and a second surface facing in a direction opposite to the first surface may include a first cover for covering at least a part of the second surface of the electronic device, and a second member disposed on an inner or outer surface of the first cover and containing a material attracted to a magnetic body or a magnet. When seen from above the first cover, the second member may be disposed substantially at the center of the first cover.

According to various embodiments of the present disclosure, the electronic device may further include a second cover for covering at least a part of the first surface of the electronic device.

According to various embodiments of the present disclosure, the second cover may be rotatably connected to the first cover, and open or close the first surface of the electronic device by rotating with respect to the first cover.

According to various embodiments of the present disclosure, a first member containing a material attracted to a magnetic body or a magnet may be disposed inside the electronic device, and when the first cover is engaged with the electronic device, the second cover may be at least partially overlapped with the first member, when seen from above the first cover.

According to various embodiments of the present disclosure, an accessory device may include a cover unit for covering at least a part of an electronic device, and a second member disposed on the cover unit and attracted to a magnetic body. If the cover unit is placed on a wireless charger, the second member may be attracted to a magnetic body provided in the wireless charger, thereby aligning the cover unit on the wireless charger.

According to various embodiments of the present disclosure, the second member may contain an amorphous metallic material.

According to various embodiments of the present disclosure, a first member attracted to a magnetic body may be disposed inside the electronic device, and with the cover unit covering at least a part of the electronic device, the second member may be provided on the cover unit in correspondence with the first member.

According to various embodiments of the present disclosure, the cover unit may include a first cover for covering at least a part of a second surface of the electronic device, and a second cover for opening or closing at least a part of a first surface of the electronic device, and the second member may be provided on at least one of the first cover or the second cover.

According to various embodiments of the present disclosure, the second cover may be rotatably connected to the first cover, and open or close the first surface of the electronic device by rotating with respect to the first cover.

According to various embodiments of the present disclosure, the accessory device may further include an attachment portion for attaching the second member onto the cover unit, surrounding the second member.

According to various embodiments of the present disclosure, an electronic device may include a housing, a cover unit for covering at least a part of the housing, and a second member disposed on the cover unit and attracted to a magnetic body. If the cover unit is placed on a wireless charger, the second member may be attracted to a magnetic body provided in the wireless charger, thereby aligning the cover unit on the wireless charger.

As is apparent from the foregoing description, an electronic device according to various embodiments of the present disclosure may smoothly receive wireless power from a conductive pattern of a wireless charger, since a conductive pattern (for example, coil) of the electronic device is aligned with a coil of the wireless charger.

An accessory device detachably engaged with an electronic device according to various embodiments of the present disclosure may enable smooth transfer of wireless power from a conductive pattern of a wireless charger to a conductive pattern (for example, coil) of the electronic device, the conductive patterns being aligned with each other, in the state where the accessory device is engaged with the electronic device.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a housing having a first surface facing in a first direction and a second surface facing in a second direction opposite to the first direction;
a conductive pattern provided inside the housing;
a first member provided between separated portions of the conductive pattern, and comprising a material attracted to at least one of a magnetic body or a magnet;
a second member configured to at least partially overlap with the first member, when viewed from above the housing, apart from the first member in the first or second direction, and comprising a material attracted to a magnetic body or a magnet; and
a circuit connected electrically to the conductive pattern and configured to wirelessly receive external power using the conductive pattern.

2. The electronic device of claim 1, wherein at least one of the first member or the second member comprises an amorphous metallic material.

3. The electronic device of claim 2, wherein the amorphous metallic material is an Fe-based amorphous alloy, a Co-based amorphous alloy, or a nanocrystalline alloy.

4. The electronic device of claim 3, wherein the amorphous metallic material is the Fe-based amorphous alloy comprising an Fe—Si—B alloy or an Fe—Si—B—Co alloy.

5. The electronic device of claim 3, wherein the amorphous metallic material is the nanocrystalline alloy comprising an Fe—Si—B—Cu—Nb alloy.

6. The electronic device of claim 1, wherein the first member and the second member are formed of a same material.

7. The electronic device of claim 1, wherein the first member or the second member is disposed substantially at a center of the housing, when seen from above the housing.

8. The electronic device of claim 1, further comprising a first cover configured to cover at least a part of the second surface of the housing,
wherein the second member is disposed on the first cover.

9. The electronic device of claim 8, wherein the first cover is detachably engaged with the housing.

10. An accessory device comprising:
a first cover configured to detachably engage with an electronic device and cover at least a part of a second surface of the electronic device; and
a second member disposed on an inner or outer surface of the first cover and comprising a material attracted to at least one of a magnetic body or a magnet,
wherein when seen from above the first cover, the second member is disposed substantially at a center of the first cover.

11. The accessory device of claim 10, wherein the accessory device further includes a second cover configured to cover at least a part of a first surface of the electronic device.

12. The accessory device of claim 11, wherein the second cover is rotatably connected to the first cover and is configured to open or close the first surface of the electronic device by rotating with respect to the first cover.

13. The accessory device of claim 11, wherein when the first cover is engaged with the electronic device, the second cover is configured to at least partially overlap with a first member in the electronic device comprising a material attracted to at least one of a magnetic body or a magnet, when seen from above the first cover.

14. An accessory device comprising:
a cover unit configured to cover at least a part of an electronic device; and
a second member disposed on the cover unit and attracted to a magnetic body,
wherein if the cover unit is placed on a wireless charger, the second member is attracted to a magnetic body in the wireless charger, and configured to align the cover unit on the wireless charger.

15. The accessory device of claim 14, wherein the second member comprises an amorphous metallic material.

16. The accessory device of claim 14, wherein when the cover unit covers the at least a part of the electronic device, the second member is disposed on the cover unit in correspondence with a first member in the electronic device that is attracted to a magnetic body.

17. The accessory device of claim 14, wherein the cover unit comprises:
a first cover configured to cover at least a part of a second surface of the electronic device; and
a second cover configured to open or close at least a part of a first surface of the electronic device, and
wherein the second member is provided on at least one of the first cover or the second cover.

18. The accessory device of claim 17, wherein the second cover is further configured to:
rotatably connect to the first cover; and
open or close the first surface of the electronic device by rotating with respect to the first cover.

19. The accessory device of claim 14, further comprising an attachment portion surrounding the second member, and configured to attach the second member onto the cover unit.

20. An electronic device comprising:
a housing;
a cover unit configured to cover at least a part of the housing; and
a second member disposed on the cover unit and attracted to a magnetic body, wherein if the cover unit is placed on a wireless charger, the second member is attracted to a magnetic body provided in the wireless charger, thereby aligning the cover unit on the wireless charger.
